(19) United States
(12) Patent Application Publication
(10) Pub. No.: US 2018/0061562 A1
(43) Pub. Date: Mar. 1, 2018

(54) INDUCTOR AND PROTECTION CIRCUIT

(71) Applicant: NTN CORPORATION, Osaka (JP)

(72) Inventors: Shougo KANBE, Aichi (JP); Kayo SAKAI, Aichi (JP); Eiichirou SHIMAZU, Aichi (JP); Takayuki ODA, Aichi (JP)

(21) Appl. No.: 15/561,512

(22) PCT Filed: Mar. 11, 2016
(86) PCT No.: PCT/JP2016/057746

§ 371 Date: Sep. 25, 2017

(30) Foreign Application Priority Data
Mar. 23, 2015 (JP) 2015-060191

(51) Int. Cl. H01F 27/42; H01F 27/28; H01F 27/24; H01F 27/40; H02H 3/02

(52) U.S. Cl. CPC H01F 27/42; H01F 27/28; H02H 3/025; H01F 27/402; H01F 27/24

(57) ABSTRACT

To provide an inductor capable of suppressing decrease of inductance in large current without magnetically saturating a magnetic core in large current of several thousand amperes like serge current and to provide a protection circuit using the inductor. The inductor is formed of an iron-based magnetic core 3 having a main coil 2 therein. A short circuit coil 4 having a function of cancelling a magnetic field generated by application current applied to the main coil 2 and having a coil winding start and a coil winding end being short-circuited is arranged coaxially with the main coil 2 in the magnetic core 3. The magnetic core 3 has magnetic cores with the same shape abutted on an abutting face 5. The protection circuit has a circuit breaker connected between a direct current power source and a load, and a current limiting inductor is connected to the circuit breaker in series.

### TECHNICAL FIELD

The present invention relates to an inductor and a protection circuit, especially relates to an inductor such as a transformer, a reactor, a choke coil, a filter, and a sensor in large current and large magnetization force, and a protection circuit using the inductor.

### BACKGROUND ART

In recent years, current flowed in a circuit has become large current with high frequency in association with improvement of a function of a power semiconductor such as a switching element and a diode. In association with that, an inductor such as a reactor, a choke coil, and a transformer used in the circuit is required to be dealt with large current with high frequency.

Further, a use for handling large current such as a converter for a solar power generator or a wind power generator and a data center has been increased, and a countermeasure against an instantaneous large current noise called serge current such as thunder becomes important in those apparatuses.

In a conventional inductor, a generated magnetic flux is increased by inserting a magnetic core into a winding, and miniaturization and high efficiency of the inductor are achieved by reducing a leakage magnetic flux.

On the other hand, a noise reduction device which reduces noise interference generated in a medical device or a computer control precision electronic device by consuming a part of noise current, which is superimposed on a conductive wire such as a power supply wire and a ground wire, in a resistor arranged in a winding side circuit by electromagnetic induction between the conductive wire and the winding and by suppressing the noise current, which is superimposed on the conductive wire, is known (see Patent Document 1). In the noise reduction device, a ferrite material with less loss in a high frequency range is used for a cylindrical core, and a winding which penetrates a hollow part of the cylindrical core is wound, and an impedance element is arranged on the winding.

Further, in electric apparatuses, it is necessary to protect a device and a person from an electric accident such as a short circuit and a leakage of electricity, and therefore an apparatus used for the protection should be activated immediately. On the other hand, in the electric apparatuses, when ON/OFF of a switch or a circuit breaker is operated or an instantaneous power failure occurs, rush current is generated. Therefore it is necessary that a protection apparatus is not erroneously activated by the rush current. In order to fulfill such demands conflicting with each other, various protection apparatuses such as a fuse, a circuit breaker and a relay are used in accordance with a configuration of a circuit.

In the protection apparatuses, in particular, the fuse is broken due to melting itself when the fuse is activated, and thereby replacing operation to replace the fuse with a spare fuse is necessary, and therefore there is a demand to use a protection apparatus other than the fuse.

In the circuit breaker or the relay which is not necessary to be replaced, a switch is mechanically activated by using an electromagnet, thermal deformation of the material or the like, and thereby it is difficult to activate immediate breaking compared to the fuse. In order to activate immediately, it is necessary to increase current. Accordingly, in a case in which the circuit breaker or the relay is used against the short circuit, since a long time is taken to activate the breaking compared to the fuse, the device or the like might not be protected because large short circuit current is flowed in the circuit to be protected. From this viewpoint, especially in a direct current circuit to which high voltage of several hundred voltage or more is applied, a fuse is generally used as a short circuit protection apparatus.

In order to use the circuit breaker as a substitute for a fuse in such a use, the breaking should be activated before the short circuit current flowed in the circuit becomes large, or alternatively the short circuit current should be suppressed not to be too large until the breaking is activated. Thus, in order to suppress the rush current due to the short circuit within the rated current of the circuit breaker, a method in which an inductor called a current limiting coil is connected in series is known (for example, see Non Patent Document 1 and Patent Document 2).

### PRIOR ART DOCUMENTS

### Non Patent Document

Non Patent Document 1: JUERGEN HAEFNER, BJOERN JACOBSON “Proactive Hybrid HVDC Breakers—A key innovation for reliable HVDC grids” CIGRE International Symposium in Bologna

### Patent Documents

Patent Document 1: WO 2011/136232 A
Patent Document 2: WO 2015/015831 A

### SUMMARY OF THE INVENTION

### Problems to be Solved by the Invention

However, in an inductor in which a magnetic core is arranged in a winding coil, in order to prevent magnetic saturation of the magnetic core, a gap is formed or a shape of the magnetic core is made large, and thereby a shape of the inductor becomes larger. Further, the material which is hardly magnetically saturated under large magnetization force is expensive. Further, in a case in which large current such as serge current is flowed in the inductor, even if the material which is hardly magnetically saturated under large magnetization force is adopted, the magnetic core is magnetically saturated and thereby the inductor may not work. In the noise reduction device disclosed in Patent Document 1, when the magnetization force becomes larger in association with the increase of current, magnetic flux density is increased and permeability is decreased. Thus, it is difficult to ensure high inductance under large magnetization force.

Further, in a protection circuit of an electric apparatus in which the inductor called a current limiting coil is connected together with the circuit breaker in series, the time until the circuit breaker is activated might be long.

An object of the present invention is, in order to solve the problems described above, to provide an inductor capable of suppressing decrease of inductance in large current without magnetically saturating a magnetic core in large current of several thousand amperes like serge current.

Further, another object of the present invention is to provide a protection circuit using a circuit breaking inductor capable of controlling a current waveform such that a current value is increased quickly and short circuit current is suppressed not to be too large in order to shorten a time until a circuit breaker is activated at an early stage of short circuit in a direct current circuit.

### Means for Solving the Problems

An inductor according to the present invention is provided with a main coil, a magnetic coil in which the main coil is embedded, and a short circuit coil having a function of cancelling a magnetic field generated by application current applied to the main coil. Especially, the short circuit coil and the main coil are arranged coaxially with each other. The short circuit coil has a coil winding start and a coil winding end being short circuited or connected via a resistor having small resistance. Further, the magnetic core is formed of an iron-based magnetic body.

A protection circuit according to the present invention is used in a direct current circuit in which a circuit breaker is connected between a direct current power source and a load. The protection circuit has a current limiting inductor connected in series to the circuit breaker. In the protection circuit, the current limiting inductor is formed of the inductor according to the present invention. Especially, the current limiting inductor is formed such that a coupling coefficient K between the main coil and the short circuit coil is decreased as the application current is increased. Further, a ratio α (α=−dK/dA) of the decrease of the coupling coefficient K in association of the increase of the application current becomes larger than α of when K is more than 0.5 with respect to K=0.5 as a border.

### Effects of the Invention

In the inductor according to the present invention, since the short circuit coil having the function of cancelling the magnetic field generated by the application current applied to the main coil is arranged coaxially with the main coil, the following effects can be obtained.

(1) Magnetization force generated in the magnetic core can be reduced.

(2) Magnetization force generated in the short circuit coil can be controlled by a coupling coefficient, the number of turns, a direct current resistance of the short circuit coil or the like. With this, high inductance can be kept by controlling permeability in working current.

(3) Since the magnetization force generated in large current can be reduced, high permeability and high inductance can be obtained in a case in which a cheap material such as ferrite in which high permeability can be obtained only under low magnetization force.

(4) Since high permeability can be obtained in large current, it is possible to design a small sized inductor. With this, for example, the small sized inductor using a cheap material can ensure high inductance in large current of several thousand amperes like serge current.

The protection circuit according to the present invention has the current limiting inductor being connected in series to the circuit breaker. Since the inductor has the short circuit coil having the function of cancelling the magnetic field generated by the application current applied to the main coil, a time until the circuit breaker is activated can be shortened at an early stage of the short circuit in the direct current circuit. Further, current, which can activate the breaker immediately in an instantaneous activation mode or the like, can be supplied to an electromagnetic coil of the breaker, and increase of the current after exceeding a required current value can be suppressed. By using the protection circuit according to the present invention, the circuit breaker can be used more safely as a substitute for a fuse.

### BRIEF DESCRIPTION OF THE DRAWINGS

FIGS. 1(a) and 1(b) are views illustrating one example of an inductor according to the present invention.

FIG. 2 illustrates measurement values measured when current is changed.

FIG. 3 is a diagram illustrating a direct current circuit to which a protection circuit is connected.

FIG. 4 is a plane view of the inductor used in Example 4.

FIG. 5 is a graph illustrating a current change when electric power is applied.

FIG. 6 is a graph illustrating a coupling coefficient K between a main coil and a short circuit coil.

### MODE FOR CARRYING OUT THE INVENTION

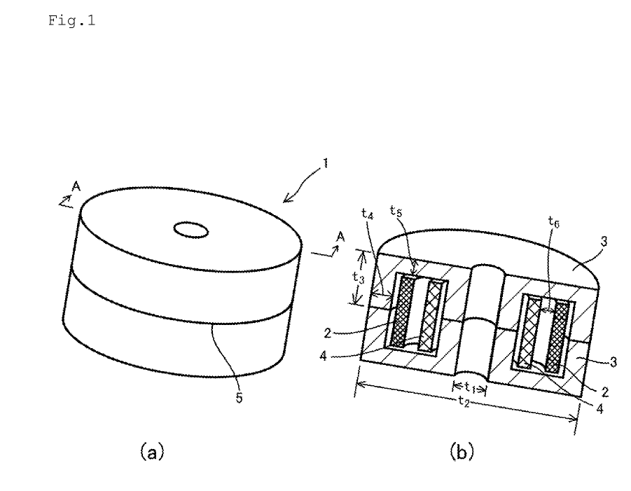

FIGS. 1(a) and 1(b) illustrate one example of an inductor according to the present invention. FIG. 1(a) is a perspective view of a pot type inductor, and FIG. 1(b) is a cross-sectional view taken along a line A-A shown in FIG. 1(a). An illustration of a lead wire from a coil is omitted.

In an inductor 1, a main coil 2 in which an illustration of the lead wire is omitted is embedded in a magnetic core 3 having a cylindrical shape. A short circuit coil 4, which has a function of cancelling a magnetic field of the main coil 2, is arranged coaxially with the main coil 2 and inside the main coil 2. Further, the short circuit coil 4 may be arranged outside of the main coil 2 as long as the short circuit coil 4 is arranged coaxially with the main coil 2. In the present invention, to arrange coaxially denotes that coil center axial directions of wound coils are substantially the same direction. Preferably, the coil center axial directions are the same direction. Further, to arrange coaxially includes a configuration in which the main coil and the short circuit coil are arranged in the magnetic core such that directions of lines of magnetic force passing coil center axes of wound coils are substantially the same direction in a forward direction or in a backward direction. A reference sign 5 is an abutting face of the magnetic core 3 in manufacturing.

A copper enamel wire can be used as a winding which forms the main coil 2. As a kind of the copper enamel wire, an urethane wire (UEW), a formal wire (PVF), a polyester wire (PEW), a polyesterimide wire (EIW), a polyamideimide wire (AIW), a polyimide wire (PIW), or a double covered wire combining thereof, a self-fusing wire, a litz wire or the like can be adopted. The copper enamel wire having a sectional shape of a circle or a rectangle can be adopted. Especially, a coil in which winding density is improved by superposing and winding a short side of a wire having a sectional shape of a flat rectangle on the magnetic core can be obtained.

The main coil 2 is preferably formed integrally with resin by embedding the main coil 2 in the resin. Any resin can be adopted as a resin body in which the main coil 2 is embedded as long as the resin can fix the main coil 2 and add insulation performance to the main coil 2. Preferably, thermosetting resin such as epoxy resin and silicon resin which can be used in resin sealing by means of potting or injection, or thermoplastic resin which can be used in injection molding can be adopted. Examples of the thermoplastic resin include polyolefin such as polyethylene and polypropylene, polyvinyl alcohol, polyethylene oxide, polyphenylene sulfide (PPS), liquid crystal polymer, polyether ether ketone (PEEK), polyimide, polyetherimide, polyacetal, polyether sulfone, polysulfone, polycarbonate, polyethylene terephthalate, polybutylene terephthalate, polyphenylene oxide, polyphthalamide, polyamide, and mixtures of these thermoplastic resins. Of these thermoplastic resins, the polyphenylene sulfide (PPS) is more preferable because the polyphenylene sulfide (PPS) has excellent flowability in the injection molding so as to coat a surface of a molded body after the injection molding with a layer thereof and further has excellent heat resistance.

As the injection molding, for example, a molding method of molding a resin body by injecting resin into a molding die for the coil, the molding die having a movable half and a fixed half being abutted with each other and the main coil 2 being arranged therein, can be adopted. The injection molding condition is different in accordance with a kind of the thermoplastic resin, however for example, in a case in which the polyphenylene sulfide (PPS) is used, it is preferable that a resin temperature is set in a range between 290 and 350° C. and a molding die temperature is set in a range between 100 and 150° C.

As the resin body in which the main coil 2 is embedded, thermosetting resin such as epoxy resin and phenol resin used as binding resin of the magnetic core 3 can be adopted other than the thermoplastic resin described above.

Any coil can be used for the short circuit coil 4 as long as a coil winding start and a coil winding end are short-circuited. Further, the short circuit coil 4 is preferably arranged coaxially with the main coil 2. By arranging short circuit coil 4 coaxially with the mail coil 2, the magnetic field generated by energizing the main coil 2 is applied to the short circuit coil 4, and thereby the magnetic field can be canceled efficiently. Further, by changing the number of turns of the coil, a diameter of the copper wire, and a coupling coefficient due to a perspective arrangement of the main coil 2 and the short circuit coil 4, the magnetization force generated in the short circuit coil 4 can be controlled. Thus, the permeability of the magnetic core 3 in the current applied to the main coil 2 is controlled, and thereby an inductor capable of keeping high inductance in large current can be obtained.

A similar winding to the main coil 2 can be used for the winding which forms the short circuit coil 4. Further, a cylindrical member formed of a conductive body can be also used for the short circuit coil. The short circuit coil 4 is preferably formed integrally the rein by embedding the short circuit coil 4 in the resin similar to the main coil 2.

The magnetic core 3 is preferably formed of an iron-based magnetic body. The iron-based magnetic body can be manufactured by applying insulation treatment to a surface of powder of, for example, a pure iron, an iron-silicon-based alloy, an iron-nitrogen-based alloy, an iron-nickel-based alloy, an iron-carbon-based alloy, an iron-boron-based alloy, an iron-cobalt-based alloy, an iron-phosphorus-based alloy, an iron-nickel-cobalt-based alloy, an iron-aluminum-silicon-based alloy (Sendust alloy), an iron-amorphous-based material or a fine crystal material and then by applying compression molding to the powder. Among these magnetic powders, a pure iron is preferable, and reduced iron powder and atomized iron powder used in powder metallurgy are especially preferable. Further, water atomized iron powder is preferable in a cost and in a treatment performance of insulation coating.

The surface of the magnetic powder particle described above is preferably coated with a nonorganic insulation body. A kind of a nonorganic insulation material is not especially limited, and a material conventionally used in dust cores can be used. Examples of preferable insulation material include metal phosphate such as iron phosphate, manganese phosphate, zinc phosphate, calcium phosphate, and aluminum phosphate; and metal oxide such as silicon oxide, magnesium oxide, aluminum oxide, titanium oxide, and zirconium oxide. Example of a commercial product of the iron-based soft magnetic powder coated with the nonorganic insulation material includes a product named Somaloy manufactured by Hoganas Sweden AB.

The magnetic body which forms the magnetic core 3 is manufactured, for example, by pressure-molding the material powder described above having the insulation coating formed on the surfaces of particles of the material powder or by pressure-molding powder in which the thermosetting resin such as epoxy resin is added to the material powder described above so as to form a compressed powder compact and thereafter by baking the compressed powder compact. The thermosetting resin such as epoxy resin is added when a problem in strength might occur.

The epoxy resin used in the present invention is preferably formed as an adhesive epoxy resin with a softening temperature of between 100 and 120° C. For example, the epoxy resin which is in a solid state at a room temperature, in a paste state at a temperature of between 50 and 60° C. and in a fluid state at a temperature of between 130 and 140° C., and is cured after the heating is further continued, can be adopted. The curing reaction is started at a temperature of approximately 120° C., however a temperature when the curing reaction is finished within a practical curing time of, for example, two hours, is preferably set in a range between 170 and 190° C. In this temperature range, the curing time is between 45 and 80 minutes.

Examples of the resin component of the epoxy resin include a bisphenol A type epoxy resin, a bisphenol F type epoxy resin, a bisphenol S type epoxy resin, a hydrogenated bisphenol A type epoxy resin, a hydrogenated bisphenol F type epoxy resin, a stilbene type epoxy resin, a triazine skeleton-containing epoxy resin, a fluorene skeleton-containing epoxy resin, an alicyclic epoxy resin, a novolak type epoxy resin, an acrylic epoxy resin, a glycidylamine type epoxy resin, a triphenolphenolmethane type epoxy resin, an alkyl-modified triphenolmethane type epoxy resin, a biphenyl type epoxy resin, a dicyclopentadiene skeleton-containing epoxy resin, a naphthalene skeleton-containing epoxy resin, and an arylalkylene type epoxy resin.

The curing agent component of the epoxy resin is preferably a latent epoxy curing agent. By using the latent epoxy curing agent, the softening temperature can be set in a range between 100 and 120° C. and the curing temperature can be set in a range between 170 and 190° C., whereby an insulation coating can be formed on an iron powder, followed by compression molding and thermal curing.

Examples of the latent epoxy curing agent include dicyandiamide, a trifluoroboron-amine complex, and an organic acid hydrazide. Among these, dicyandiamide, which conforms to the curing condition described above, is preferable.

Further, a curing accelerator such as a tertiary amine, imidazole and an aromatic amine can be blended in the epoxy resin together with the latent epoxy curing agent.

The epoxy resin containing the latent curing agent described above contains the latent curing agent so that the curing conditions are 2 hours at 160° C., 80 minutes at 170° C., 55 minutes at 180° C., 45 minutes at 190° C., and 30 minutes at 200° C.

When the epoxy resin is blended, blending ratios of the iron-based soft magnetic powder, which has a surface subjected to the nonorganic insulation coating treatment, and the epoxy resin are set in a range between 95 and 99% by mass of the iron-based soft magnetic powder and set in a range between 1 and 5% by mass of the epoxy resin containing the latent curing agent with respect to the total amount of the iron-based soft magnetic powder and the epoxy resin. This is because when the ratio of the epoxy resin is less than 1% by mass, improvement in strength is not expected, and when the ratio of the epoxy resin is more than 5% by mass, the magnetic properties are deteriorated, and a resin-rich coarse agglomerate is produced.

In the magnetic body in which the epoxy resin is blended, an uncured resin coating is formed on the nonorganic insulation coating formed on the surface of the iron-based soft magnetic powder by dry blending the iron-based soft magnetic powder, which has the surface described above subjected to the nonorganic insulation coating treatment, and the epoxy resin described above at a temperature of between 100 and 120° C. The iron-based magnetic powder having the insulation coating on the surface thereof is molded to form a molded body by means of compression molding using a molding die, and then the magnetic body formed of the integrated molded body is obtained by thermally curing the molded body at a temperature of a thermal curing start temperature or more of the epoxy resin.

Further, the magnetic body which forms the magnetic core 3 is also manufactured by injection molding a mixture in which the iron-based soft magnetic powder and the binding resin are blended. As the binding resin, the thermoplastic resin, which can be used in the injection molding, can be adopted. As the thermoplastic resin, a resin body as same as the resin body described above into which the coil is embedded can be adopted. Among those, the polyphenylene sulfide (PPS) is more preferable because the polyphenylene sulfide (PPS) blended in the iron-based soft magnetic powder has excellent flowability in the injection molding so as to coat a surface of a molded body after the injection molding with a layer thereof and further has excellent heat resistance.

A ratio of raw powder is preferably set in a range between 80 and 95% by mass with respect to the total amount of the raw powder and the thermoplastic resin as 100% by mass. When the ratio of the raw powder is less than 80% by mass, the magnetic property is not obtained, and when the ratio of the raw powder is more than 95% by mass, injection molding performance is inferior.

As the injection molding, for example, a method of molding the molded body by injecting the raw powder into a molding die having a movable half and a fixed half being abutted with each other can be adopted.

The inductor according to the present invention shown in FIGS. 1(a) and 1(b) is obtained by arranging the main coil 2 and the short circuit coil 4 in the magnetic core 3 divided into two parts in a vertical direction in the cross-sectional view shown in FIG. 1(b). The two parts into which the magnetic core 3 is divided are mutually bonded by using a solventless type epoxy adhesive or the like at the abutting face 5.

The inductor according to the present invention can be used in a serge countermeasure circuit, a short circuit prevention circuit, a noise filter circuit in large current, a protection circuit of a direct current circuit to which the circuit breaker is connected, and the like.

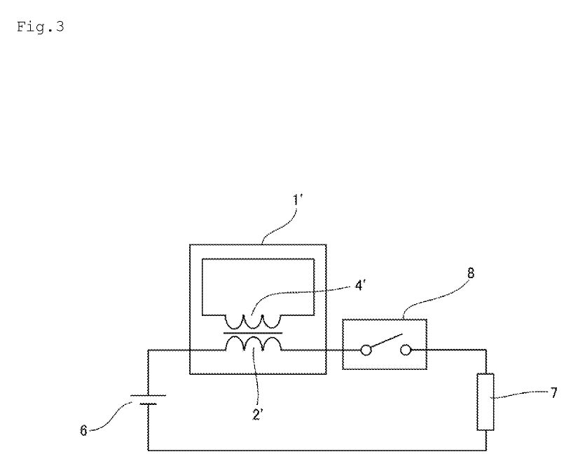

FIG. 3 illustrates one example of a configuration in which the inductor is applied to a protection circuit of a direct current circuit. FIG. 3 is an example of the direct current circuit to which the protection circuit is connected.

An current limiting inductor 1′ provided as a protection circuit, a circuit breaker 8, and a load 7 are connected in series in this order between a direct current power source 6 and the load 7. The circuit breaker 8 used in the present invention is formed as a fully electromagnetic wiring breaker having a characteristic in which the time until breaking becomes shorter as a value of current flowed in a relay part of the breaker becomes larger. The current limiting inductor 1′ connected to the circuit breaker 8 in series is provided with a main coil 2′ and a short circuit coil 4′ magnetically joined to the main coil 2′. The inductor 1′ is used by connecting the main coil 2′ to a direct current main circuit. The short circuit coil 4′ is activated when a large current change in the direct current circuit is generated due to the short circuit of the load 7 or the like. The short circuit coil 4′ is formed to suppress the increase of the current at a primary side in accordance with characteristics of the circuit breaker 8 used in the direct current breaking circuit. Specifically, the short circuit coil 4′ is formed to increase the current quickly until a current value in which the circuit breaker 8 can be activated in a predetermined time by suppressing an influence of the inductor 1′ to be slight, and is formed to suppress the increase of the current after the current exceeds a predetermined current value.

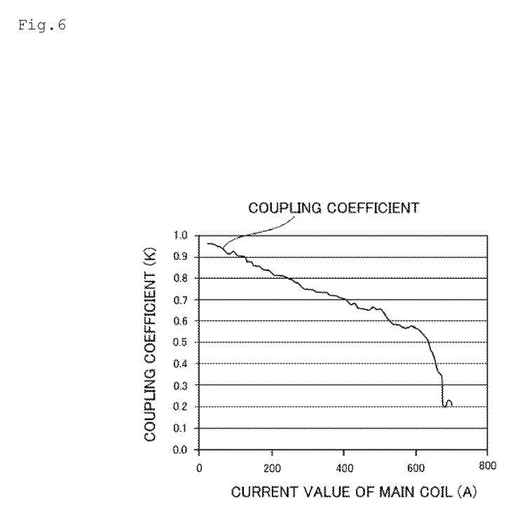

In a normal transformer or the like, it is important that the coupling coefficient K is not changed in accordance with the current value. However, it is found that the coupling coefficient K between the main coil 2′ and the short circuit coil 4′, which form the current limiting inductor 1′ according to the present invention, is decreased as the current flowed in the main coil 2′ becomes larger and the increase of the current can be made extremely gentle around K≦0.5 (see FIG. 6). That is, a ratio α (α=−dK/dA) of the decrease of the coupling coefficient K becomes larger than α of when K is more than 0.5 with respect to K=0.5 as a border. As a result, the effect to suppress the current when the large current is flowed is obtained by setting the current limiting inductor such that the coupling coefficient K is set to be equal to or less than 0.5 in any current value. Further, a can be set in any manner by adjusting a shape of the magnetic core, the number of turns of the main coil, the number of turns of the short circuit coil, and a resistance of each coil. For example, the current value in which α is extremely changed can be shifted to a large current side by increasing the number of the turns of the shirt circuit coil, decreasing a magnetic resistance of a magnetic circuit, enlarging a value of saturation magnetic flux density of the magnetic core, and/or increasing the number of the short circuit coils, enlarging a wire diameter of the short circuit coil and decreasing the resistance of the short circuit coil.

The protection circuit according to the present invention can control the current waveform such that the short circuit current becomes not too large while increasing the current value quickly in order to activate the circuit breaker immediately at an early stage of the short circuit in the direct circuit, and thereby the protection circuit according to the present invention can be used in a battery charger such as a quick battery charger for electric vehicles; a high voltage direct current power supply system (HVDC) used for a data center, a smart house and the like; a direct current power generator such as a solar power generator and the like.

### EXAMPLES

### Example 1

A pot type magnetic core 3 having a hollow part to arrange the coil therein shown in FIG. 1 was manufactured by using iron powder (Somaloy: insulation coating treatment iron powder manufactured by Hoganas Sweden AB) in which a powder surface is covered with a nonorganic insulation coating. The magnetic core 3 is formed in a pot shape having an inner diameter (t₁) of 28 mm, an outer diameter (t₂) of 120 mm, a height (t₃) of 36.5 mm, a lateral thickness of the hollow part (t₄) of 12 mm, and a vertical thickness of the hollow part (t₅) of 10 mm. Two of the magnetic cores 3 were manufactured.

A rectangular section insulation winding having a width of 5 mm and a thickness of 4.5 mm was prepared and a coil having an inner diameter of 80 mm, an outer diameter of 90 mm, and a height of 50 mm was manufactured by winding the rectangular section insulation winding to be an edgewise winding. The coil is arranged at one side of the magnetic core 3 and a lead wire is fixed.

On the other hand, a short circuit coil having an inner diameter of 54 mm, an outer diameter of 64 mm, and a height of 50 mm and having a turn ratio of the coil (main coil 2) having the lead wire and the short circuit coil (coil 4) to be set to 10:1 was manufactured by using the rectangular section insulation winding described above. In the short circuit coil, a coil winding start and a coil winding end are electrically connected to each other. The inductor shown in FIG. 1 was manufactured by arranging the short circuit coil in the coil having the lead wire described above and covering a whole of the coil by using another magnetic core 3. A coil gap (t₆) between both coils is 7 mm.

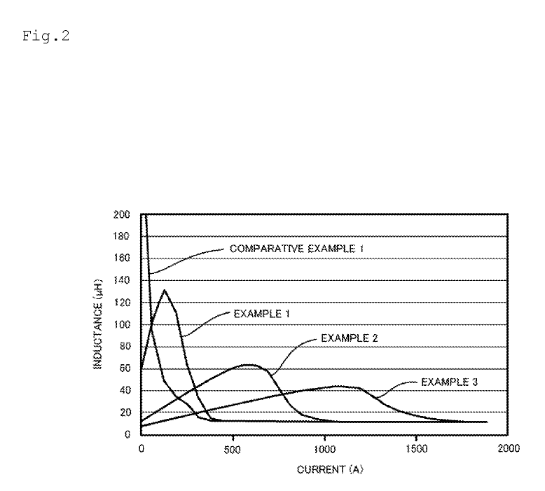

The inductance of the obtained inductor was measured by an LCR meter while changing the current value. FIG. 2 illustrates the result thereof.

### Example 2

An inductor similar to that of the example 1 except that the inductor has a turn ratio of the coil having the lead wire and the short circuit coil to be set to 10:3 was manufactured. The inductance was measured by a similar method to that of the example 1. FIG. 2 illustrates the result thereof.

### Example 3

An inductor similar to that of the example 1 except that the inductor has a turn ratio of the coil having the lead wire and the short circuit coil to be set to 10:5 was manufactured. The inductance was measured by a similar method to that of the example 1. FIG. 2 illustrates the result thereof.

### Comparative Example 1

An inductor similar to that of the example 1 except that the shirt circuit is not arranged was manufactured. The inductance was measured by a similar method to that of the example 1. FIG. 2 illustrates the result thereof.

As shown in FIG. 2, in the inductor of the comparative example 1, large inductance is obtained when application current is small, however the inductance is decreased in accordance with the increase of the current. Compared to the comparative example 1 in which the short circuit coil is not arranged, in each example, by arranging the short circuit coil, the inductance is small when the current is small, while the inductance is increased as the current becomes larger. As shown by the example 1 to the example 3, when the coupling coefficient is increased, a peak value of the inductance is shifted to a large current side.

Further, in the present invention, a kind of the magnetic material is not especially limited, and a similar tendency can be obtained in the materials disclosed in JP 4763609 B, JP 5069962 B, and JP 2014-062230 A.

### Example 4

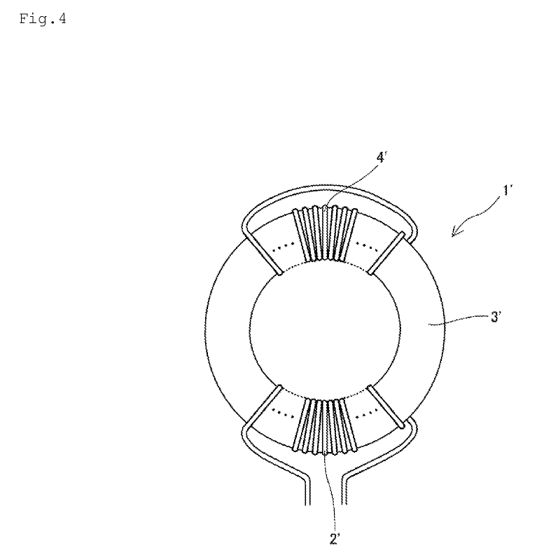

FIG. 4 illustrates an inductor of an example 4. FIG. 4 is a plane view of the inductor.

An inductor 1′ provided with a main coil 2′ and a short circuit coil 4′ was manufactured. Each of the main coil 2′ and the short circuit coil 4′ has 16 turns of windings wound around an amorphous dust core 3′ (green compact density of 5.6 g/cm³) having an outer diameter φ of 20.2 mm, an inner diameter φ of 12.5 mm and a thickness t of 6.4 mm. A copper enamel wire having a diameter of 0.6 mm is used in each of the main coil 2′ and the short circuit coil 4′. In the short circuit coil 4′, a coil winding start and a coil winding end are electrically connected to each other. Further, the coupling coefficient K at 700 A is set to 0.2 by adjusting a wire diameter of the short circuit coil 4′, a turn ratio of the main coil 2′ and the short circuit coil 4′, and the number of turns of each of the main coil 2′ and the short circuit coil 4′.

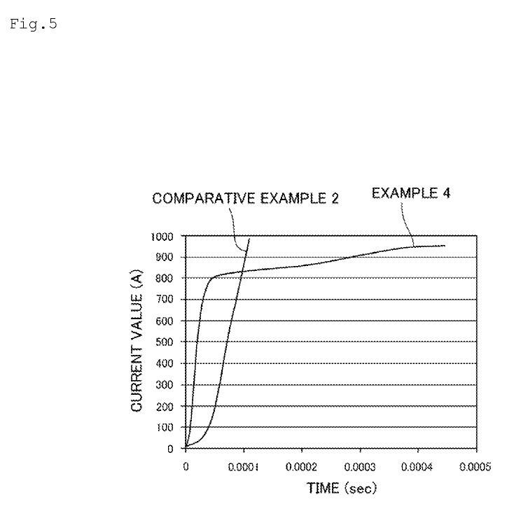

As a short circuit accident of the obtained inductor is simulated, a current change when electricity having voltage of 60 V is applied to the inductor 1′ from a non-energized state was measured. FIG. 5 illustrates the result thereof.

### Comparative Example 2

An inductor similar to that of the example 4 except that the shirt circuit is not arranged was manufactured. The current change was measured by a similar method to that of the example 4. FIG. 5 illustrates the result thereof.

In the inductor of the example 4, a current limiting effect in which the current is increased quickly at an early stage and then the increase of the current is suppressed when the current exceeds a predetermined current value is obtained. As a result, the current waveform can be controlled such that the short circuit current becomes not too large while increasing the current quickly in order to activate the circuit breaker at the early stage of the short circuit in the direct current circuit.

On the other hand, in the inductor of the comparative example 2 having a general configuration in which the short circuit coil is not arranged, magnetic saturation occurs when the current exceeds several tens amperes, and then the excessive increase of the current begins, and therefore the current waveform cannot be controlled.

### INDUSTRIAL APPLICABILITY

The inductor according to the present invention can be used as an inductor for electric apparatuses used in a state in which magnetic saturation is prevented from occurring in large current because the short circuit coil is embedded at a predetermined position. Further, by using the inductor according to the present invention in a protection circuit of a direct current circuit, a circuit breaker can be used more safely as a substitute for a fuse.

### REFERENCE SIGNS LIST

1: inductor
2: coil
3: magnetic core
4: short circuit coil
5: abutting face
6: direct current
7: load
8: circuit breaker

1. An inductor comprising:
a main coil;
a magnetic coil in which the main coil is embedded; and
a short circuit coil having a function of cancelling a magnetic field generated by application current applied to the main coil.

2. The inductor according to claim 1, wherein the short circuit coil and the main coil are arranged coaxially with each other.

3. The inductor according to claim 1, wherein the short circuit comprises a coil winding start and a coil winding end being short-circuited.

4. The inductor according to claim 1, wherein the magnetic core is formed of an iron-based magnetic body.

5. A protection circuit comprising a current limiting inductor connected in series to a circuit breaker connected between a direct current power source and a load,
wherein the current limiting inductor is formed of the inductor according to claim 1.

6. The protection circuit according to claim 5, wherein the current limiting inductor is formed such that a coupling coefficient K between the main coil and the short circuit coil is decreased as the application current is increased.

7. The protection circuit according to claim 5, wherein a defined by the following expression becomes larger than α of when K is more than 0.5 with respect to K=0.5 as a border.
α=−dK/dA
Here, α denotes a ratio of decrease of the coupling coefficient which is decreased in association with increase of the application current, K denotes the coupling coefficient between the main coil and the short circuit coil, and A denotes the application current.
